(19) United States
(12) Patent Application Publication
(10) Pub. No.: US 2005/0268499 A1
(43) Pub. Date: Dec. 8, 2005

(54) Method and apparatus for pumping with a dredge

(76) Inventors: Harry Peter Weinrib, El Cajon, CA (US); Daniel K. Wahlgren, Escondido, CA (US)

Correspondence Address: FITCH,EVEN,TABIN & FLANNERY, 120 SOUTH LASALLE STREET, SUITE 1600, CHICAGO, IL, 60603-3406, US

(21) Appl. No.: 10/861,588

(22) Filed: Jun. 4, 2004

(51) Int. Cl. G01F 1/00

(52) U.S. Cl. 37/326

(57) ABSTRACT

A system usable for dredging may include a suction bypass system for automatically maintaining a sufficiently high, liquid flow velocity. Preferably, a flow sensor monitors flow velocity and when the monitor flow decreases to an extent that plugging may occur, a liquid bypass valve is opened and an intake line valve is closed until the flow velocity increases whereupon the valves are returned to their original positions. An automatic level cut removes a relatively constant layer of material from a contoured bottom. The illustrated automatic level cut process comprises adjusting the force with which the suction head engages the bottom, moving the suction head in a direction opposite to the direction of the swing of the boom to keep the suction head pointing straight ahead, and maintaining the suction head to stay substantially level with the bottom even though the angle of the boom increases to the surface of the water body. A leveling device comprising a parallelogram linkage may be used to maintain the suction head substantially level with the bottom. A predetermined amount of load force may be applied by the head against the bottom. Herein, a winch and cable and the controller are operated to lift some of the head weight until the desired predetermined head force is applied to the bottom. A walking system moves the pipe intake for taking a sideways cut without the use of a spud pole, anchors and anchor lines. Large blade members or feet travels in an endless path with the feet entering the bottom while vertically disposed and remained disposed vertically while entering and leaving the bottom so as not to dig or stir the bottom that will cause large liquid turbidity. A low turbidity head cleaning system prevents the head from being plugged and debris or sticky material. Preferably, a rotatable cone-shaped head is provided with spaced rings and bars that define sized openings that limit the size of debris entering into the intake. A fixed comb removes material stuck on the rotating head. A shroud has an open bottom side thereby preventing bottom material from escaping and increasing with turbidity. A suction head articulation system keeps the head pointed in the forward direction of dredge advancement to create a smooth finish grade.

This invention relates to a dredge pumping system for dredging material from the bottom using an articulated head and a suction pump to cause a mixture of material and liquid to flow into a suction inlet and a pipe and through the pump for later discharge.

### BACKGROUND OF THE INVENTION

Many rivers and harbors have contaminated materials on the bottom of the water body usually in a layer. It is desirable to remove this layer and to remediate the contaminated hazardous waste material in this layer by various technologies. Several problems have been encountered which has prevented the widespread removal of contaminated material on the bottom including the turbidity to the water caused by using a conventional drag line and bucket type of dredging removal and the cost of remediation of the dredged material. Often the drag bucket takes a fixed depth of cut, e.g., a three foot depth and leaves a flat bottom. This drag line and bucket is not suitable for following the diverse topography of a river bed to remove substantially only the contaminated layer on the top of the diverse topography. From a cost standpoint, the first depth of cut, e.g., three feet from the bottom, a bucket removes too much material from the bottom where the contaminated layer may vary from, e.g., seven inches to one foot or even two feet in some places. Manifestly, the dredging and pumping of the non-contaminated material involves additional unwanted cost; and moreover, all of the dredged material has to be treated by a remediation process. This excessive removal of non-contaminated material results in a significantly increased remediation costs because all of the dredged material has to be treated. It would be most desirable to remove the contaminated layer with a significantly smaller amount of non-contaminated material, e.g., reaching a goal of only 10 to 15 percent of non-contaminated material.

Thus, it will be seen that unlike typical drag line and bucket dredging in a river or harbor for maintenance dredging to keep a channel open to a given depth with a flat bottom the goal in environmental dredging, the goal is often to remove only a specific layer in which the contaminated material is located from this uneven, underwater topography or terrain which is also littered with many obstacles and debris as typically found on the bottom of a harbor, river or the like. The depth of the contaminated layer may vary from place to place in the harbor or river and its depth can be ascertained, e.g., by core sampling techniques. In many instances, the contaminated material is a less dense layer deposited on top of a denser, uncontaminated substrate, e.g., a clay or rock bedrock. Rather than using a line and bucket type of removal for marine environmental remediation, attempts have been made to use hydraulic dredging technology that is less damaging to marine life in the water column than the mechanical technologies using a bucket or the like, but have been unsuccessful. Typically, because most of the conventional existing hydraulic dredging technology is unable to closely follow the diverse terrain levels found at the remediation site or are unable to remove the layer without exceeding turbidity standards. As a result of not being able to closely follow the diverse terrain to remove substantially only the contaminated layer, they often either remove too little, leaving some of the contamination behind or they significantly over-dredge and take too much of the uncontaminated material. All of this excess material which is not contaminated must also be treated as if it were contaminated.

As stated above, in marine environmental remediation, it is desired to have a smooth, level top finish after removing only a specified depth of material; for example, two or three feet, even through the terrain is uneven at the bottom of the harbor or the like. For such dredging, it is desirable that the suction head move and operate automatically in three dimensions, usually swinging to the left and to the right and moving downward into the harbor bottom and moving forwardly in the direction of dredge travel. Thus there is a need for self-leveling, ground following head such that the pump suction is always in close proximity to the targeted material and taking the contaminated material with a minimum amount of over-dredging of non-contaminated material.

One of the problems involved in dredging harbor bottoms or other bottoms in a liquid is that the slurry often becomes so concentrated that it begins to cause plugging and a substantial slow down of the velocity of the slurry mixture flowing through the pipe. The slurry mixture becomes so concentrated and the velocity slows down to a point, the flow can actually stop when the pipeline has become plugged. Unplugging is one of the worse problems in an environmental remediation project because the operation is stopped with a pipeline full of contaminated material that often backflows into the liquid column causing a turbidity and pollution problem. The plugging often requires pipeline flushing with clean liquid or water before the problem can be assessed and corrected, which again increases the amount of contaminated material and turbidity. Thus, there is a need for a new and improved system which can reduce intake plugging or pipeline plugging and be done with considerably less contamination and turbidity. In addition to the debris there is often encountered a large amount of debris in the bottom of the harbor or the like and the debris being caught in the suction inlet can cause considerable delays and problems before the debris is removed from the inlet.

The intake to the dredge head often becomes plugged with debris and sticky materials that are present at most dredge sites. Often a screen is provided about the intake line to prevent large debris or materials from entering the intake and plugging the intake. When the intake is plugged, the entire dredging operation stops usually for a considerable period of time and the head is manually cleaned to make it unplugged. This cleaning operation exposes the workers to the contaminants in a remedial dredging operation, and the water column is also filled with contaminated material removed from the intake causing turbidity. The problem with pipeline plugging is that there is often an unavoidable backflow pollution as the material in the intake pipe flows backward into the water column. Manifestly, any plugging and manual labor to unplug results in considerable downtime costs.

Another problem with conventional dredges is the way that they are repositioned for taking successive cuts on the bottom. Repositioning usually involves an anchor barge and a crew to move a pair of heavy anchors at the opposite ends of the cuts and the dropping of a rigid spud pole which enters the ground at the back of the dredge and which acts as a pivot point for the head and barge to swing about. Cables extend from the barge to the anchors at the opposite ends of the intake and by pulling on the respective swing tables, the head having the pump intake is lowered into the sediment and the swing cables will pull the dredge to the left and to the right to form an arc-shaped cut path. When the amount of the material has been removed from this particular positioning, the spud pole must be again removed and the anchoring barge and crew move the heavy anchors to the new repositioned places for the next cutting operation at which the spud is against dropped to act as a pivot for the next swing. This operation takes a considerable amount of time which could otherwise be spent for producing flow and dredging of material and requires the maintaining of and the expense of an anchor barge and a crew to shift the anchors.

### SUMMARY OF THE INVENTION

In accordance with one embodiment, there is provided a new and improved dredging system which is particularly adapted for remedial, hydraulic projects, although it can be used for other projects where the problem of low turbidity is not a problem and the release of contaminants is not a particular problem. This is achieved by providing systems that solve a number of problems particularly when doing a remedial project to remove and to clean a relatively thin contaminated layer, e.g., two feet or less from the bottom of a harbor, river or the like. Often the depth of the layer may be quite thin, for example, six inches to one foot and it is possible to remove this layer with a very reduced amount of uncontaminated material thereby reducing the cost of dredging and the cost of the remediation process. Also, a unique traction system may be used to shift a suction head without causing a lot of turbidity. More specifically, the environmental dredging system may include one or more of systems for the dredge which includes a suction bypass system for maintaining a sufficiently high velocity of flow to prevent plugging, an automatic level cut system for removing a relatively thin layer of material from a contoured bottom, a low turbidity and anti-plugging head inlet system for preventing sticky material and debris from plugging the head, and a walking system for moving the head to take a cut without having to use a spud pole and the anchored swing lines of conventional systems.

The problem of intake plugging and pipeline plugging is addressed by a suction bypass system which automatically shifts into a bypass mode when the pipeline flow velocity reaches a critical lower limit causing a stopping of material intake and the replacing of the material intake by a water only intake which dilutes the mixture and allows the velocity to restore to an acceptable value. Thereafter the suction bypass system shifts back to the main suction mode and allows the contaminated material to be taken in through the inlet. In this illustrated embodiment, the bypass system includes a valve at the bypass suction water inlet which is normally closed until the velocity flow being monitored lowers to within a range which indicates that plugging may be about to occur, upon which actuators simultaneously or shortly thereafter open the bypass water inlet valve while a main suction valve adjacent the inlet for the slurry mixture is closed. In this bypass mode, backflow from the main suction pipe is prevented as would be the case if the inlet were not closed by the valve.

The water flowing through the bypass inlet valve and intake opening dilutes the mixture and the velocity should restore to a acceptable value whereupon the system again shifts back to the main suction mode by closing the bypass water inlet valve and opening the main suction valve to allow the contaminated material to again be sucked into the pipeline for flow therethrough.

In one illustrated embodiment, the dredge is provided with an automatic level cut system which is designed to provide a smooth level cut, even through the terrain is uneven or contoured and this is achieved by adjusting the suction head so that it is always pointing in the forward direction of dredge advance regardless of the angle of the boom and so that it is in close proximity to the bottom target material being removed with a minimum of over-dredging.

This is achieved by sensing a change in the swing angle of the boom in one direction and applying force to the suction head to move it in the opposite direction to counteract the change in the swing angle of the boom relative to the dredge. Preferably, a master fluid cylinder has opposite ends connected to the boom and dredge and senses a change in the swing angle of the boom and forces fluid through a line to a slave cylinder, which is connected at opposite ends to the boom and the suction head, to swing the suction head in the opposite direction by an equal and counteracting amount to keep the suction head pointing straight ahead.

It is preferred to select a preset load or weight that the dredge head is applying to the ground to achieve the automatic level cut and this is accomplished through a mechanical linkage and fluid transfer system that does not require an operator input, unless the operator desires to do so. To this end, a load cell is attached to the end of the hoisting cable to register the total weight of the head system and indicates how much of the system weight is to be supported by the ground. After having inputted a value for the preset weight that the head is to be applying to the ground, the computer or programmable logic controller will automatically adjust the hoisting winch to maintain this desired ground pressure to give the depth of cut desired. Usually for contaminated material such as for example a PCB layer, is usually deposited on top of a denser, uncontaminated substrate such as clay or bedrock and this specific ground pressure selected for the site and the depth of removal allows the dredge head to penetrate the less dense target material and to ride on top of the undesired lower substrate. Thus, the dredge head can follow the uneven terrain and target the less dense or granular contaminated materials and leave the harder, underlying, uncontaminated layers in place so that a large amount of contamination material is not missed or a significant amount of over-dredging occurs that requires the treating of the excess over-dredged material as though it was contaminated.

The automatic level cut process which is designed to provide a smooth level cut preferably comprises adjusting the force at which the suction head engages the bottom to make a cut removing a layer of bottom material, shifting the suction head from side-to-side while making the cut, pointing the suction head straight ahead in the direction of travel after making a side-to-side cut, and maintaining the suction head substantially level with the bottom when the suction head is making a cut whether in shallow or deeper water.

It is preferred to maintain the suction head at a substantially level position with respect to the bottom even though the lower end of the boom carrying the suction head increases its angle with respect to the surface of the body of water as the outer boom end is lowered from making a cut in a shallower water to making a cut in deeper water. This is achieved by a leveling device mounted on the boom and connected to the suction head. In the illustrated embodiment, the leveling device is a parallelogram linkage having a pair of longitudinal link members extending longitudinal of the boom and a rear, more vertical link member, and a forward link member connected to the forward ends of the pair of longitudinal link members for positioning the suction head at a level position as the boom forward end swings to a deeper position. In the illustrated embodiment, a bottom side of a cone-shaped guard about the suction head is positioned by the parallelogram linkage to maintain the bottom side of the cone-shaped guard substantially parallel to the bottom as the boom forward is lowered into deeper water to make cuts at deeper depths.

In accordance with an embodiment of the invention, there is provided a low turbidity head cleaning system which prevents the head from becoming plugged with debris and sticky material and prevents pipeline plugging and a consequential, unavoidable backflow pollution into the water column when the system is shut down and the expensive downtime to unplug the head which is done manually. This is achieved in this embodiment by a cone-shaped, rotatable head mounted around the outside of the stationary, main suction intake pipe. The rotating head is comprised of spaced support bars and rings which have large, sized openings therebetween. The size of the openings depends on the size of the pump being used and the size of the over-sized material desired to be prevented from entering the intake pipe and plugging the system. The cone-shaped, rotating low turbidity head also distributes the weight of the head system onto the ground. Herein the cone-shaped head is cleaned by fixed cone-type assembly mounted adjacent the head to remove material which maybe stuck between the rings. The low turbidity aspect of the system is a result of having a flexible rubber shroud about the cone that prohibits contaminated material from escaping the area inside the cone except through the suction pipe.

In accordance with one embodiment of the invention, the dredge is provided with a submersible, walking swing system that moves the suction inlet or intake for the pump through the normal swing cut and replaces the conventional swing cables and anchor system of conventional dredges. This system maintains a constant connection with the ground and walks the pump inlet using large bladed members or feet that enter into the ground in the vertical position. While inserted in the ground, a large, vertical face of the foot pushes directly against the shear strength of the bottom material while not tearing it up and out as like a conventional paddle wheel would do. The traction provided by these vertical blade feet and the walking rotation is that it provides high traction with a minimum amount of turbidity. The preferred and illustrated walking system comprises a rotatable head which is motor driven and is located just behind a submersible pump located adjacent the intake head. This walking system has a set of arms extending outwardly about an axis where each of the arms bearing a pair of double bladed feet which are always kept in a vertical position as the arm carries it through a 360° of rotation. Each arm carries the double-bladed foot to engage and move directly into the ground and as the next blade is being pushed down to enter the ground, the previously deepest penetrating bladed foot is being pulled upwardly by its arm to leave the ground with the head having been walked in the direction of rotation of the blade carrying head. Thus, the expensive barge used to move the anchor points and the expense of the crew to move the anchor points and the lost down time for shifting the anchor points may be eliminated with the walking system of the present invention.

### BRIEF DESCRIPTION OF THE DRAWINGS

FIG. 1 is a plan view showing a swinging head movable through an arcuate swinging motion and embodying the novel features herein described;

FIG. 2 is an elevational view of the dredge and the head shown in FIG. 1;

FIG. 3 is a diagrammatic illustration of the bypass system when in the main suction mode for sucking material through the head inlet and through the pump to the dredge;

FIG. 4 is a diagrammatic illustration of the bypass system when in the bypass mode is intaking liquid to reduce the solids content in the liquid flow and thereby increase the velocity of the flow into and through the pipe;

FIG. 5 is a side-elevational view of a low turbidity intake and a head cleaning system in accordance with an embodiment of the invention;

FIG. 6 is a side view of a submersible, walking swing system in accordance with an embodiment for moving the dredge head through an arc to take a cut;

FIG. 7 is a front view showing the head in two different positions as the bladed feet performs the submersible walking between positions 7a and 7b;

FIG. 8 is a plan view of the automatic head articulation system that assures that the suction head is always pointing straight ahead in the direction of dredge travel as the boom swings from side to side;

FIG. 9 is a elevational view illustrating a load cell sensor system which provides the amount of desired pressure to be applied to the ground so that a level cut may be made and a parallelogram arrangement which assures that the front suction head assembly always stays level with the bottom no matter what depth the boom and suction head is operating at;

FIG. 10 is a diagrammatic illustration of a master and slave cylinder arrangement to keep the suction head pointed straight ahead in the direction of advancement;

FIG. 11 is a side-elevational view of the traction drive system in accordance with the illustrated embodiment;

FIG. 11a is a side-elevational view of the walking feet blades as they are driven into the ground;

FIG. 11b is a side-elevational view of a connector link between the main drive hub and the rotating eccentric hub;

FIG. 12 is a diagrammatic plan view of the walking system for swinging the boom while making a cut;

FIG. 12a is a side-view of the walking system of FIG. 12; and

FIG. 13 is an illustration of one of the walking feet as it travels through a revolution and enters and exits the ground to provide the traction for moving the suction head.

### DETAILED DESCRIPTION OF THE PREFERRED EMBODIMENT

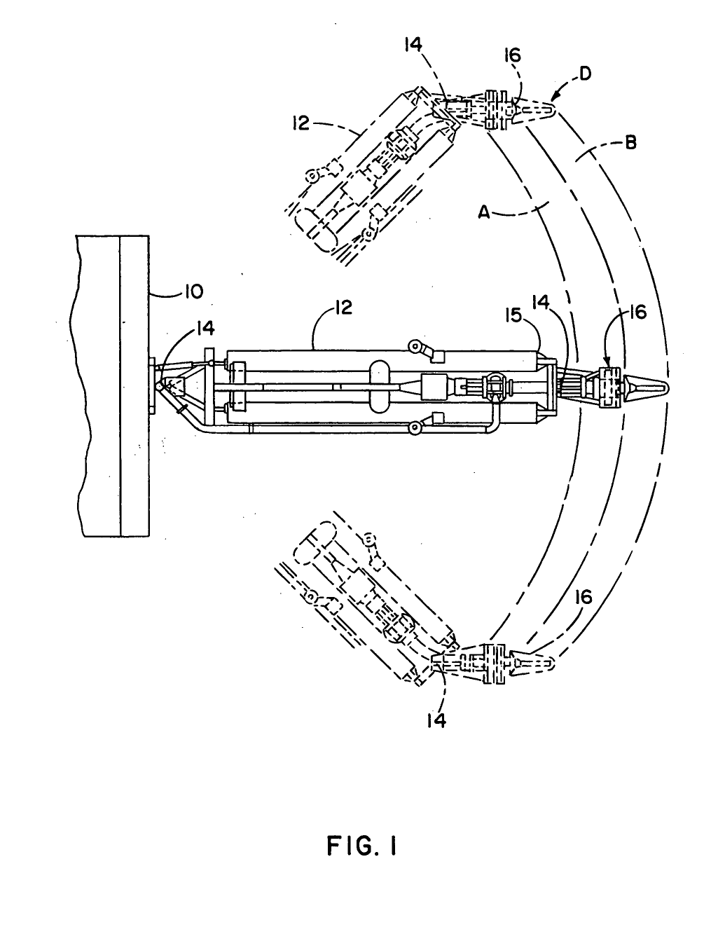

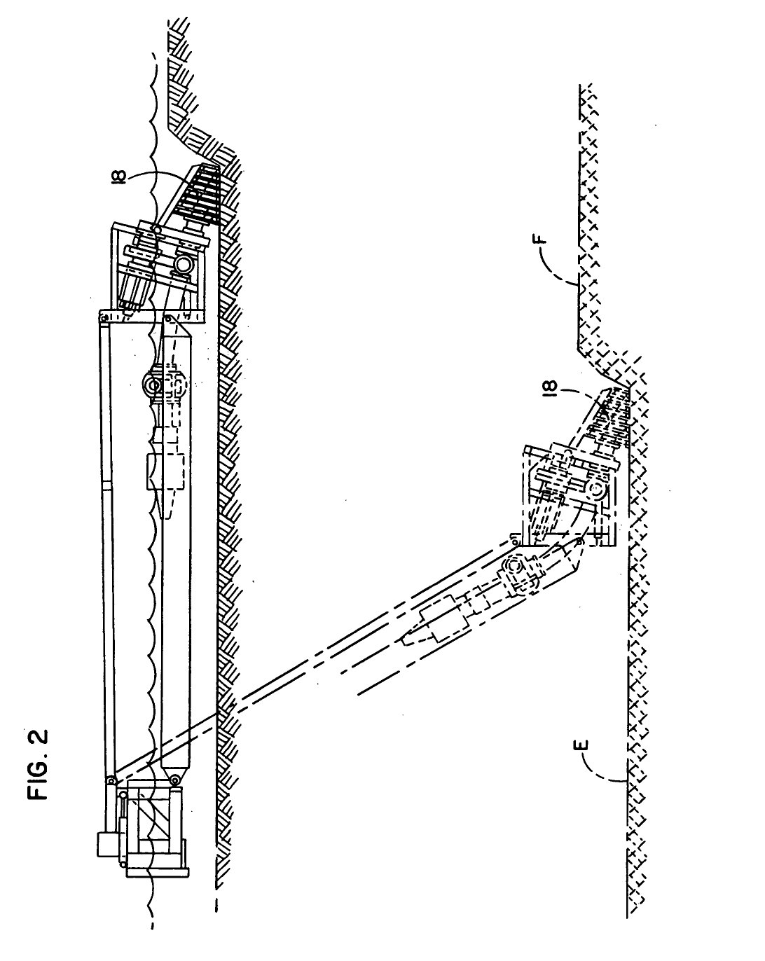

As shown in the drawings and in particularly in FIG. 1, there is a first embodiment which comprises a dredge 10 having an articulated or swingable boom 12 which pivots about a pivot mounting 14 with the dredge, which is usually a floating barge or the like. A suction head 16 extends into and is submersed at its lower end in the water. The suction head is mounted on a forward or distal end 15 of the boom and has an intake 18 for intaking material from the submerged bottom as shown in FIG. 2. The illustrated head 16 is also articulated or pivotally mounted at a pivot mounting 20 to the distal end 15 of the boom. As best seen in FIG. 1 the suction head takes a arcuate cut shown by arrow A for a first cut which is then followed by a second cut B between opposite swing points or ends of the arcuate edge C and D in FIG. 1.

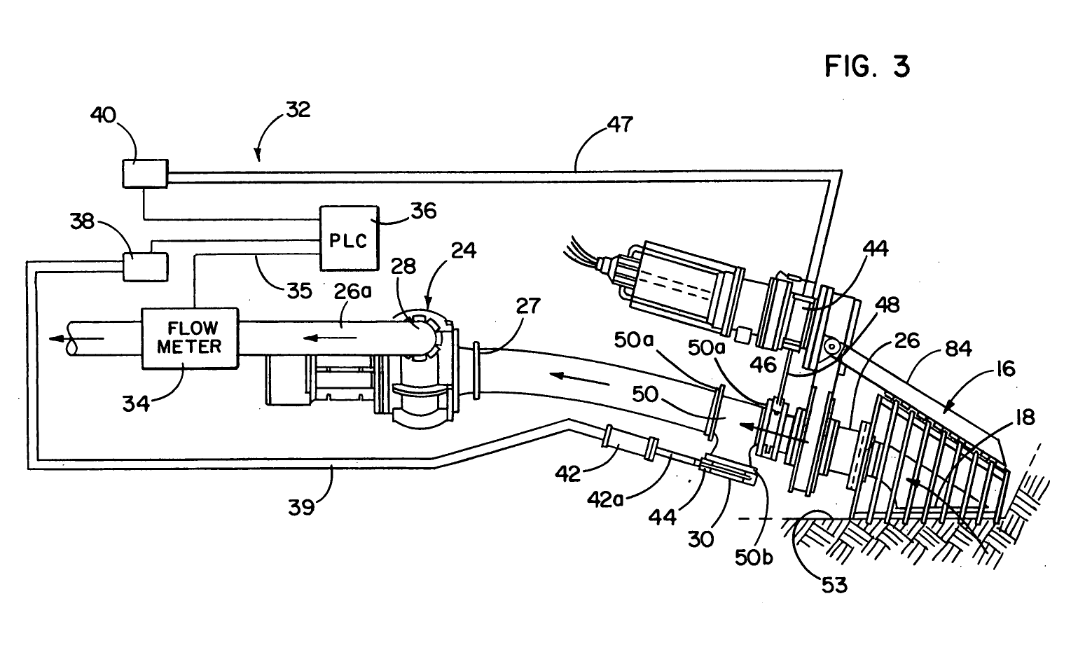

Referring to FIG. 2, the head intake 18 is shown at a lower level E having lowered a harbor bottom 22 at the cut shown in FIG. 2 from the higher elevation for the bottom shown at the level F in FIG. 2. The dredge, as illustrated in FIG. 2, is involved in an environmental dredging to remove only a specific layer of contaminated material between levels E and F in underwater terrain or bottom 22. In the present invention, a pump 24 (FIG. 3) is provided on the boom 15 rather than on the dredge itself although it is possible to mount the pump on the dredge rather than on the boom. The pump has a intake and a forward end which is connected to the suction pipe 26 which is connected to an inlet end 27 of the pump and the pump has a discharge end 28 which is connected to the suction pipe end leading to the dredge. Thus, as is seen in FIG. 3, the material from the bottom 22 of the cut being made flows inwardly through the intake 18 which is connected to the forward end of the suction pipe 26 and the material flows through the suction pipe to the intake for the pump and then is discharged from the pump at its discharge end 28 for flow through a portion 26a of the suction pipe leading to the dredge.

In accordance with the embodiment illustrated in FIG. 3, the system is provided with a bypass system which operates in a main suction mode to remove the material from the bottom through the intake 18 for flow through the pipe 26 and when the flow begins to be restricted and decreases in velocity, the system shifts to the bypass mode to intake water only through a bypass inlet 30. This increased flow of water only without the bottom material provides a diluted mixture in the suction pipe thereby causing a consequent increase in the velocity of the mixture flowing through the suction pipe. The velocity of the flow through the intake pipe 26 is measured in this instance by a flow sensor 32 which comprises a flow meter 34 which directly monitors the flow within the pipe 26. The flow meter 34 is connected by a line 35 to a controller such as a PLC controller 36. The PLC controller 36 controls a pair of hydraulic control valves 38 and 40 over hydraulic lines 39 and 47, respectively, for bypass valves 44 and 46. The control valve 38 is preferably a hydraulic control valve which is connected by the hydraulic line 39 to a valve actuator 42 for shifting a bypass valve 44 between open and closed positions. The preferred bypass valve 44 is a knifegate valve which is shown in its closed position in FIG. 3 with the actuating rod 42a of the control valve 42 extended and the valve 44 closed to prevent liquid flow through the suction inlet 30 and into the suction pipe 26. When the valve actuator 42 pulls the actuating rod 42a to the left as viewed in FIG. 3, the knifegate valve 44 is opened and water is allowed to flow through the inlet into the suction pipe 26 to dilute the slurry mixture. Manifestly, electrical or other control systems could be used rather than the illustrated and preferred hydraulic control system to open and close the bypass valves 44 and 46. Also, other than the preferred knifegate type of valves could be employed.

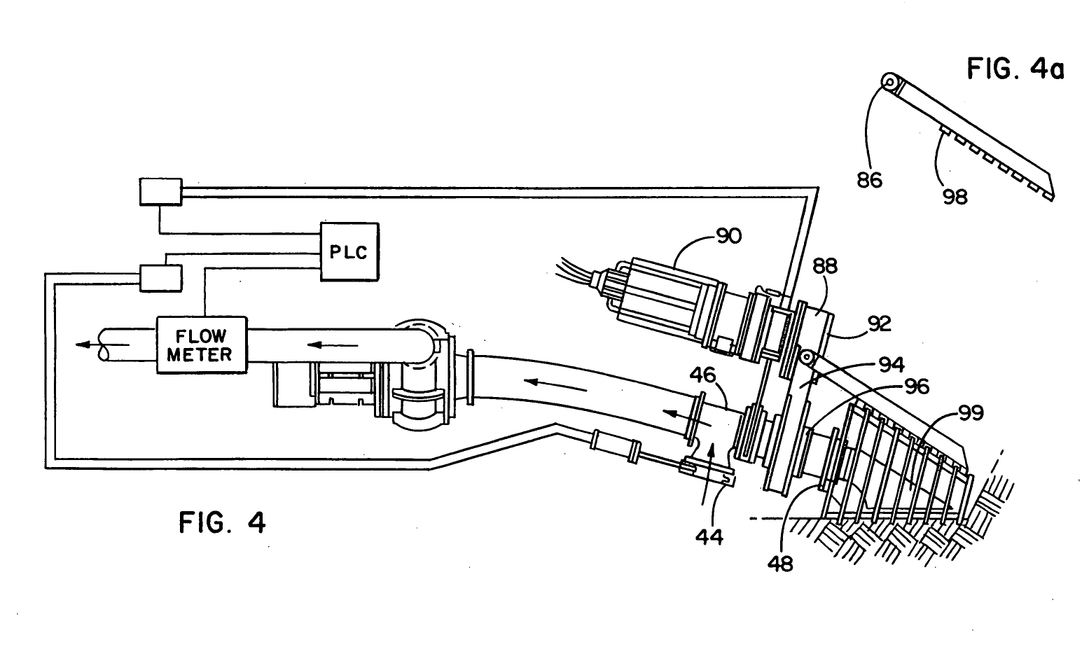

A large amount of debris and contaminated material may be flowing through the intake 18 and the intake pipe 26 during a hydraulic remediation project and it is undesirable that they be released and dropped into the water column when the system is shifted into the bypass mode to prevent plugging by increasing flow velocity in the pipe 26. To this end the backflow is prevented by a closing the knifegate valve 46 which is located adjacent the inlet end of the intake pipe 26. The controller 36 which caused opening of the bypass valve 44 also operates to close the intake pipe, index 6. The controller causes the hydraulic control valve 40, which is connected by the hydraulic control flow line 47 to the actuator 44 for the intake knifegate valve 46 to close the valve 46. The actuator 44 is preferably a hydraulic actuator which has a rod 48 which is shown in FIG. 3 position to be extended to keep the valve open with the flow flowing through the intake as shown by the directional arrows in FIG. 3 into the inlet suction pipe section 26b and through the valve 46 into the pump inlet 27 and then for flow through the pump discharge into the discharge suction pipe section 26a. FIG. 4 illustrates the bypass suction mode as shown by the directional arrows where the water from the water column is flowing through the bypass valve and through the inlet to the pump and then being discharged from the pump with the flow being monitored and by the flow sensor 32 until the velocity of the flow being discharged from the pump reaches a predetermined minimum flow or desirable flow rate so that the system may be switched back to the main suction mode illustrated in FIG. 3. As shown in FIG. 4 in the bypass suction mode, the knifegate valve 46 is in its closed position preventing material from flowing back through the intake 18 into the water column. Thus, it will be seen from the foregoing that when the pipeline velocity is monitored by the flow sensor 32 reaches a critical lower limit, the system shifts into a bypass mode of FIG. 4 immediately stopping material intake through the intake 18 and replacing it with water intake through the bypass valve 44. This incoming water dilutes the solids content of the mixture flowing through the pump and the pipe 26 until the velocity is restored to an acceptable value as monitored by the flow sensor 32 and the controller 36 which then causes the shifting back to the main suction mode of FIG. 3. Additionally, to provide a total backflow operation where there is no back flow from the pipe 26 and the pump, the controller may close both of the knifegate valves 44 and 46 so that there is no backflow either through the intake inlet 18 or through the bypass inlet 30.

The preferred and illustrated bypass system is formed inexpensively by using a simple T pipe 50 which has flanges 50a which are connected to the knifegate intake valve 46 and a flange 50b which is connected to the bypass knifegate valve 44. Thus, the bypass knifegate 44 is mounted on the branch of the T pipe 50 while the main suction knifegate valve 46 is mounted on a straight line portion of the T pipe for straight line fluid flow towards the pump. Thus, there is provided a simple and economic design using off-the-shelf knifegate valves for providing bypass and the backflow prevention.

For a marine environmental remediation, the invention is provided with an automatic level cut articulation system which is designed to provide a smooth, level cut finish even though the terrain is uneven. To this end, the suction head 16 is adjusted such that it is always pointing in the direction of the dredge advancement regardless of the angle of the boom and its swing relative to the dredge. Also, there is provided a sensing system which is to try to remove only the targeted sediment layer of the bottom which is usually in a softer layer containing the contaminated material and which is usually located over a harder substrate or layer so that mostly the targeted material is removed and with only a minimum of over-dredging of the harder underlying base material. Preferably, the sensing allows removal of the targeted soft layer over a contoured bottom which has various terrains by taking off only the upper, soft layer; for example, two or three feet layer even though the depth of the water overhead changes substantially due to the varying height of the terrain.

To keep the head 16 adjusted so that it is pointing straight ahead in the direction of the advancement of the dredge 10 which would be to the right as shown in FIGS. 1 and 2, the head is connected pivotally to the end of the boom 12 at the pivot mount 14 and an actuator drive 51 is provided to position the suction head 16 to be straight ahead, as the boom swings between two extreme, opposite end positions C and D (FIG. 1). In the middle position, the head 16 is shown pointed straight ahead as is the boom 12. As the boom swings with respect to the dredge 10 to one of its opposite end positions D or C where the head 16 is positioned at the ends of the arc of the cut, the boom is at an acute angle to the suction head 16 which is pointing straight ahead.

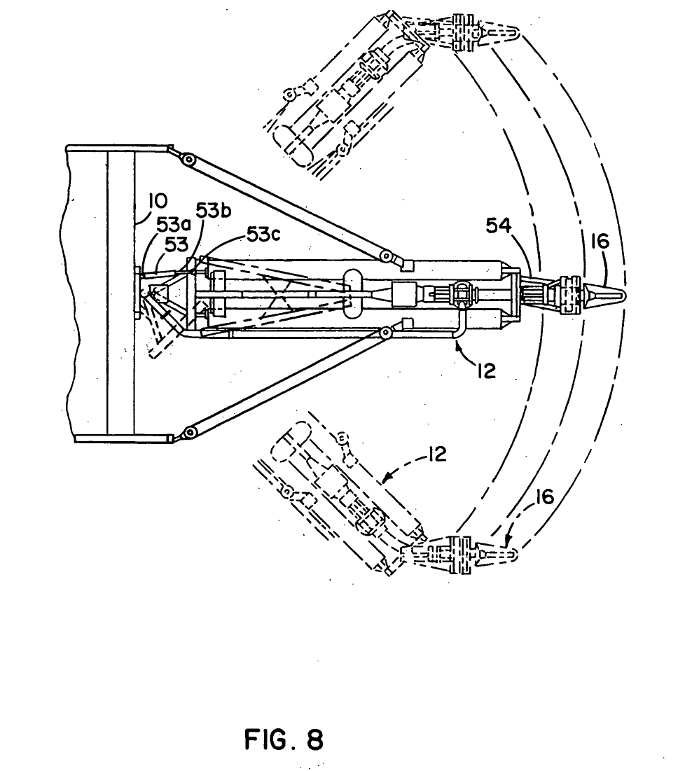

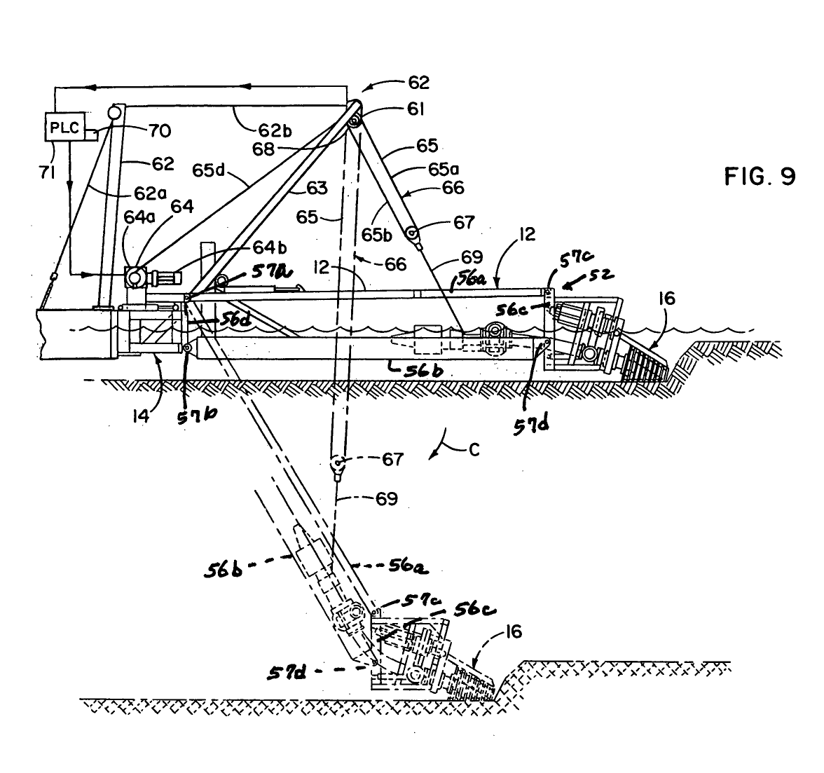

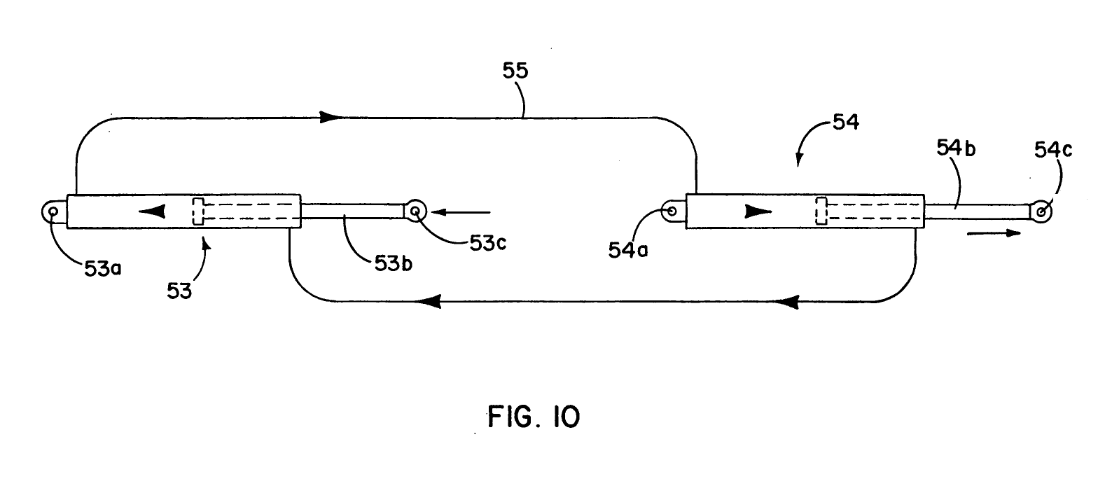

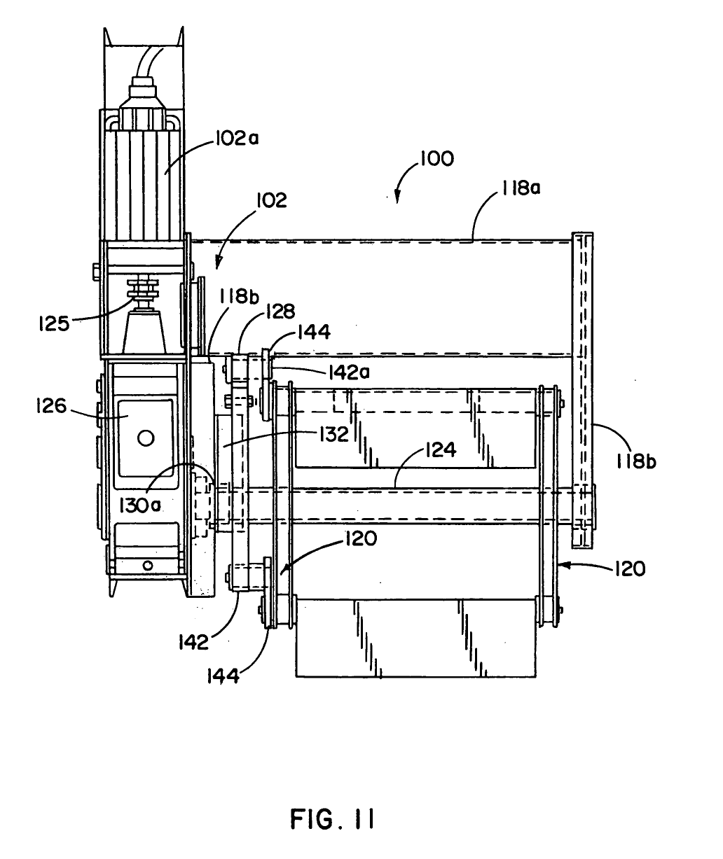

As best seen in FIGS. 8 and 9, the actuator drive 51 to point the suction head 21 straight ahead in the direction of the dredge advancement comprises a sensing means for sensing the swinging movement of the boom about its pivot point 14 with the dredge 10 to sense the angle of the swing and comprises a force supplying means for counteracting the boom swing angle change to keep the suction head 16 pointed straight ahead as the boom 12 swings and sweeps between end positions C and D of the arc of the cut. While the sensing means and the force applying means could be various devices to accomplish these functions, a very simplified force supplying and automatic actuating drive 51 is developed, and, as shown in FIGS. 8 and 9, comprises a master cylinder 53 for sensing changes in the swing angle and a slave cylinder 54 connected between the boom and the suction head for keeping the suction head 16 positioned straight ahead as the boom swings. A hydraulic circuit 55 having hydraulic lines or pipes (FIG. 9) interconnects the master cylinder 53 and the slave cylinder 54 such that as the boom swings in one direction, for example, to the left as viewed in FIG. 8, a piston rod 53b in the master cylinder compresses the fluid and causes it to flow through the hose loop circuit 55 causing slave cylinder rod 54b to extend by the exact, same amount. The opposite occurs when the boom swings to the right. More specifically, the master cylinder 53, as shown in FIG. 10, has a first end 53a pivotally connected to the dredge 10 and has its piston rod 53 having a pivoted end 53c pivotally connected to an end of the boom. The head 16 is pivotally mounted at a distal end of the boom 15 by the pivot mount 20 and the slave cylinder 54 has a pivotal mount end 54a connected to the distal end 15 in the boom with the opposite end of the piston rod 54b connected pivotally at a pivotal connection 54c to the suction head 16. As clearly is shown in FIG. 10, as the boom swings in one direction, for example, to the left as being described, the end of the boom is pushing the master cylinder rod 53b inwardly into the cylinder causing the fluid to be forced through the hydraulic circuit 55 into the slave cylinder 54 to push the piston rod 54b to extend by an equal amount. The fluid being forced outwardly of the slave cylinder is sent through a closed loop into the master cylinder behind the piston rod as it is traveling to the left as viewed in FIG. 10. When the boom swings to the right, just the opposite occurs, in that the suction head 16 pushes the piston rod 54b inwardly into the slave cylinder to force fluid to flow through the upper hydraulic line 55a into the master cylinder to push the piston rod 53b to extend to the right as viewed in FIG. 10. Thus, it will be seen that there is an automatic head articulation system that counteracts the swing angle and assures that the suction head 16 is always tracking parallel to the side of the slope as the dredge boom 12 swings left and right thereby creating a smooth finish grade.

The manner in which the boom 12 and the suction head 16 are raised and lowered is best illustrated in FIG. 9 wherein the boom 12 is shown as being substantially horizontal (upper portion of FIG. 9) for making a shallow cut on the bottom adjacent the water line. When making a deeper cut such as shown in the lower portion of FIG. 9, the boom is swung considerably downwardly in the direction of the directional arrow c in FIG. 9 with a winch cable loop 65 shown in solid lines as having a short loop 66 when the boom is generally horizontal and being a very long extended vertical loop 66 (in dotted lines) when the boom has been lowered to make a deeper water cut. As is stated previously, the boom 12 is pivotally mounted and the pivot mount 14 to the front edge of the dredge. At the front edge of the dredge is a vertical support post 62 having a cable like stay 62a extending from the dredge at the lower end of the stay cable to the upper end of the stay which is secured to the top of the vertical dredge post 62. A horizontally extending upper stay cable 62b extends from the top of the post 62 horizontally to the top of an inclined boom support 63 which has its lower end fixed to the boom at the rearward end of the boom at a location adjacent the dredge. The winch cable 65 is fixed at one end at the outer upper end of the boom support 63 and a first portion 65a of the cable extends downwardly to form one side of the loop 66 to a lower cable pulley 67 and remote portion 65b of the cable then extends upwardly to another pulley 68 secured to the upper outer end of the boom support 63. From this upper pulley 68, a cable portion 65d extends to the main hoisting winch 64 which includes a winch drum 64a and winch motor 64b. The winch is able to play out the winch cable 65 to increase the length of the cable to increase the length of the loop 66 as shown in dotted lines for lowering the suction head into deeper water or to make a deeper cut. In a reverse manner, the winch can wind the cable 65 on the winch drum to shorten the loop 66 to raise the boom and the suction head 16. A fixed length of cable 69 is connected to the pulley 67 at the bottom of the loop 66 and extends to a lower end which is connected to the forward portion of the boom, as illustrated.

To maintain an automatic level cut motion, a load cell sensor 61 of a load sensing system 60 is attached to the fixed end of the cable 65 at the upper end of the inclined boom support 63. The load sensor cell 61 essentially weighs the weight of the boom 12 and the suction head 16. When the suction head touches the ground, the load cell measures a reduction in weight force on the cable 65, that is the difference in tension force at the cable end between when the suction head is not touching the ground and when the suction head is laying on the ground. This reduction in weight force on the cable 65 represents the load which is being applied to the bottom by the boom and head. The operator inputs the desired pressure at which the suction head is to be applied to the ground through an input device 70 which is connected to a controller 71. Then the controller 71 uses this information to raise or lower the winch in order to maintain the desired pressure that is a set point of which the cut will be made by the suction head.

Thus, it will be seen that it is possible to register the total weight of the head system and to indicate how much of the system weight is being supported by the ground. The ground head pressure is adjusted to the desired amount in order to remove a specific layer of the ground. This pressure needed to remove a given layer depends on the density of the target material. It is desirable that the suction head 16 ride on top of the harder underlying substrate when removing a softer layer. In practice, the operator will input a value; for example, 800 pounds by an input device 70 into a controller 71 which controls a winch drive 64 to lift the hoisting cable 65 to remove the weight until only the 800 pound value is being used by the head against the ground providing the desired ground pressure to remove the contaminated layer. A preferred controller is a programable logic controller (PLC) which the operator inputs the value and with the controller than performing the adjustment of the winch until the desired pressure of 800 pounds is measured by the load sensor cell 61. Because the contaminated material is usually a softer layer which is deposited on top of a denser uncontaminated substrate (such as clay, bedrock, etc.), the dredge head should penetrate the less dense target material and ride on top of the undesired harder substrate. Thus is will be seen that the dredge head can follow on uneven terrain and target the less denser, granular contaminated materials and leave the harder, uncontaminated materials in place.

In addition to keeping the suction head 16 pointing straight ahead as the boom 12 swings and to adjusting the ground head pressure applied by the suction head to the bottom to remove a specific layer, the remediation system also maintains the suction head substantially level with the bottom to make a level cut even though the angle that the forward end 15 of the boom makes with the surface of the body of water changes substantially from a shallow water cut (solid lines in FIG. 9) deeper water cut (phantom lines in FIG. 9). As illustrated in FIG. 9, the suction head maintains substantially the same position even though the downward boom angle has increased substantially from the shallow water to a deeper water cut. Preferably, a leveling device 52 is provided to compensate for this change in boom angle.

In the illustrated embodiment, a leveling device 52 is provided that is simple in construction and operates automatically without operator input or without power driven devices to shift the head to compensate for changes in the boom angle. Manifestly, power devices and sensing systems, with or without operator input could be used to maintain the suction level for a level cut and to reduce overdredging rather than the illustrated parallelogram linkage kind of leveling device illustrated herein. The parallelogram linkage, leveling device 52 comprises a pair of parallel, longitudinal extending link members 56a, 56b and a pair of parallel end link members 56c, 56d. The rear link member 56d has a pivot or articulation mount 57a at its upper end to the upper longitudinal link member 56a and a pivot mount 57b at its lower end to the lower longitudinal link member 56b. The forward link member 56c has a pivot mount 57c to the upper forward end of the longitudinal link member 56a and a lower pivot mount 57d to the lower longitudinal link member 56b.

When making a shallow water cut, the longitudinally extending link members 56a and 56b are spaced farther apart, as shown in solid lines in FIG. 9 for the shallow water dredging cut, and are spaced close together, as shown in phantom line in FIG. 9, when making a deeper water dredging cut.

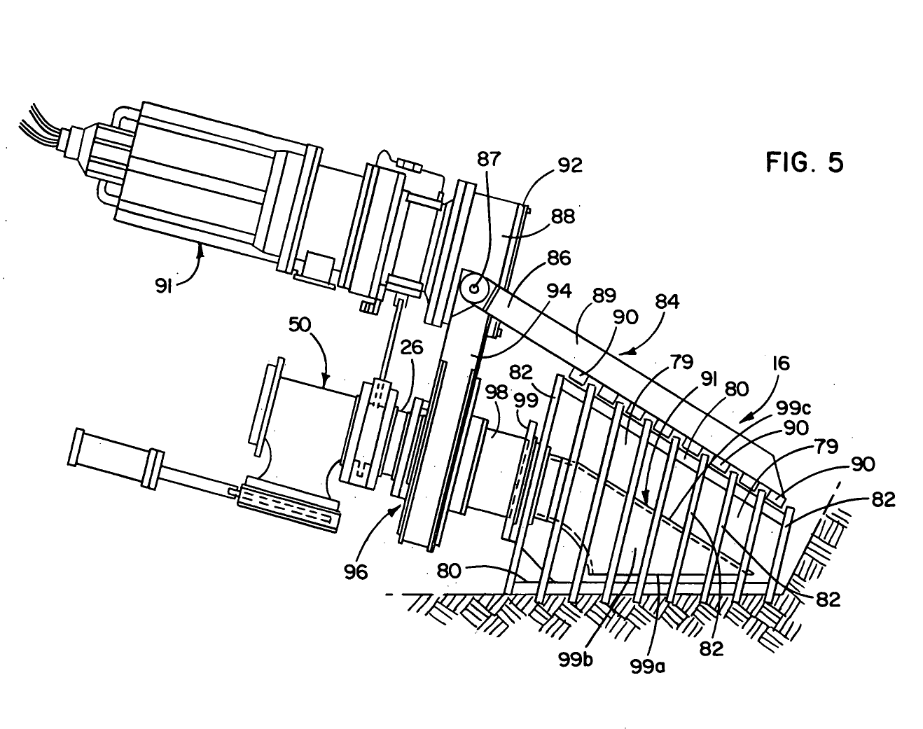

In accordance with another aspect, which will be described hereinafter in conjunction with FIG. 5, there is provided a low turbidity head cleaning system 75 which functions to prevent the dredge head intake from being plugged with large pieces of debris and sticky materials. The illustrated system includes a cone-shaped, high torque, rotating head 16 which in this instance is in a cone-shape which has openings in the head which allows the contaminated material at the bottom from entering the intake 18 but prevents the larger size of debris or sticky material from falling through the cone-shaped head and into engagement with the intake 18. Herein the cone-shaped head is comprised of main outer support bars 80 which are held together in spaced relationship with one another along the outside of the cone by equally spaced rings 82 mounted on the outside of the cone and becoming smaller in diameter as approaching the point of the cone. The spacing of the rings and the spacing of the support bars defines the size of the openings 79 which are sized depending upon the size of the pump being used.

The low turbidity aspect is enhanced by attaching a hood-shaped, flexible rubber shroud 99 that has a flat open bottom 99a with vertical side walls 99b and a curved top wall. The shroud is a piece of tough flexible rubber that hangs down and prohibits contaminated material from escaping the area inside the rotating cone except through the suction pipe inlet.

For the purpose of cleaning the rotating head and preventing it from becoming obstructed with debris and sticky material, a cleaner, preferably in the form of a fixed comb assembly 84 is mounted on the top of the rotating head. The comb assembly is pivotally connected at an inner end 86 by a pivot mount or pin 87 to a frame portion 88 which is mounted by flanges on the intake pipe 26 adjacent the bypass valve T pipe 50. The fixed comb comprises an elongated member or bar 89 which has a series of downwardly projecting members in the shape of blocks 90 which are spaced along the bar to be positioned inside the open space 79 between adjacent rings 82 and to project downwardly toward the support bars 80 and into the spaces 79 to clean any debris or material on the outer surface of the rotating head as the rotating head continuously rotates through the fixed comb.

To rotate the rotating head 16, there is provided a drive motor 91 (FIG. 5) which may be electrical or hydraulically driven to rotate and to drive a interior rotating sprocket or pulley assembly 92 fixed thereto and within an enclosed housing and having a transmission belt or chain 94 within the housing extending to a rotatable bearing support 96 having a sprocket fixed on an outer rotatable sleeve 98 which encircles and rotates about the non-rotating intake pipe 26. The sleeve 98 has a flange 99 which is mounted to the large end of the rotating head to rotate the same about the non-rotatable intake end of the intake pipe 26.

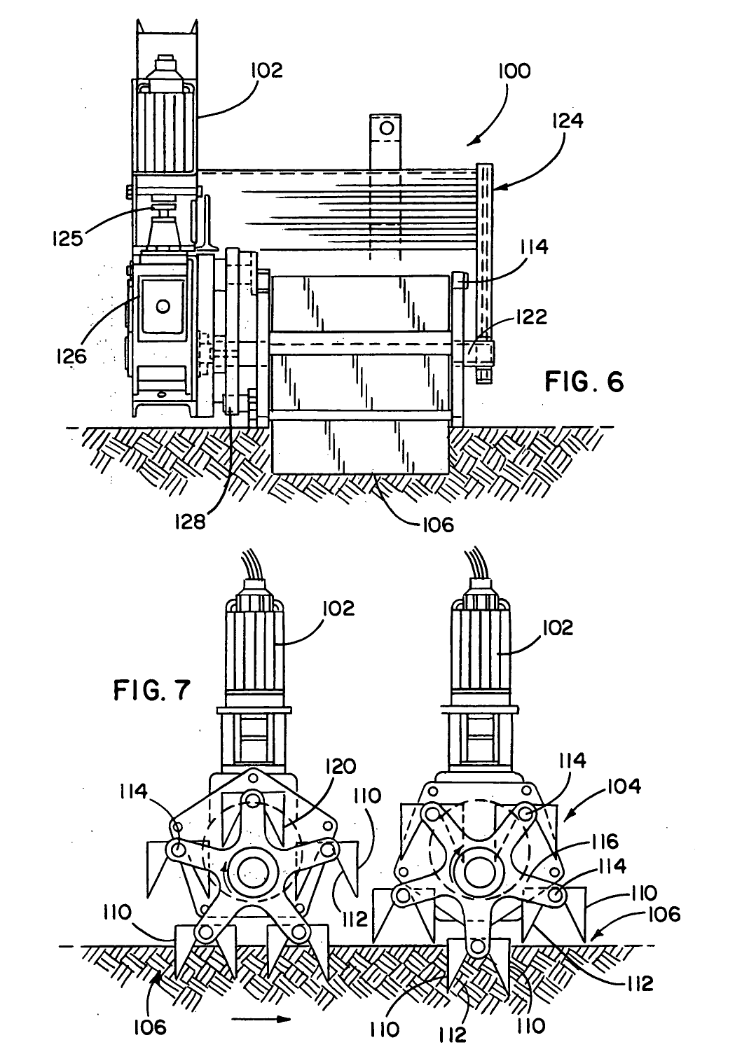

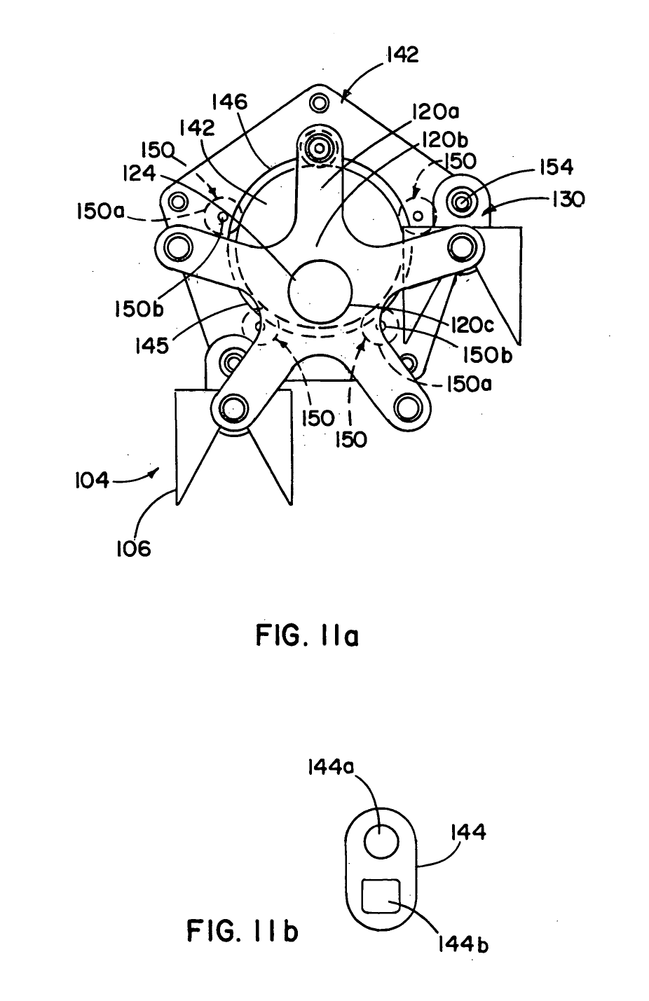

In accordance with another aspect, the embodiment uses a submersible walking and swing system rather than the constant repositioning of swing cables and anchors as the dredge advances forward into the next cut. To this end, powered submersible walking system 100 (FIGS. 6, 7 and 11-13) is located behind the pump and is motor driven such as by the submersible motor drive 102 (FIG. 11) to provide a left and right swinging motion for the boom 12. The motor drive 102 drives members 104 about an endless path and into engagement with the bottom to enter into contact with the ground and then to push against the ground to move the boom in the direction of a reaction to the direction of rotation of the members rotating in the endless path. In this illustrated embodiment, the members 104 are in the shape of large, bladed feet 106 that are directed to always enter and exit the ground while in a vertical position. When inserted into the ground, large vertical faces of the feet push directly against the material with a force that does not exceed the sheer strength of the material to tear it up and out like a conventional paddle wheel would do.

It is most desirable to limit the amount of suspended solids that are put into the water column by the bladed feet while obtaining the maximum traction to move the boom in the forward direction of taking the cut. Herein, each of the illustrated bladed feet 106 comprise a pair of left and right feet in the shape of identical wedge-shaped members 109 each of which has an outer, vertical face 110 and an inclined inner face 112. The feet are wedge-shaped or triangular in cross-section between the inclined face 112 and vertical face 110. These wedge-shaped members have a central portion 113.

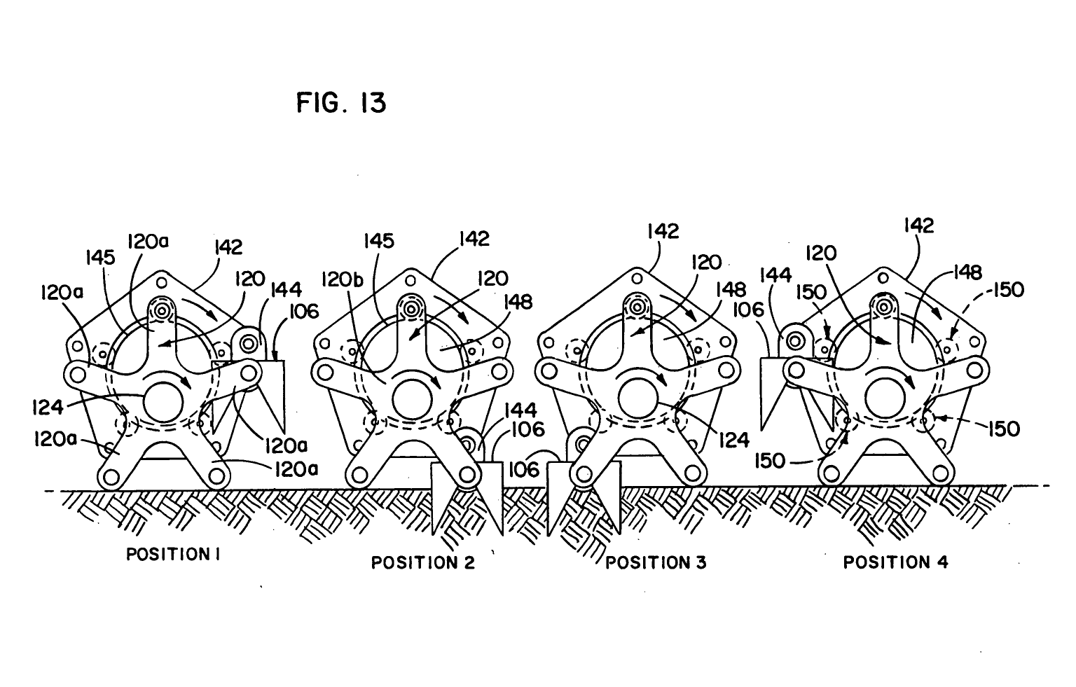

Each blade foot 106 is maintained in a vertical position with the pointed ends down as it is swung downwardly (FIG. 13) into the ground, from position 1 to position 2 in a rotation of 72 degrees. For the next 72 degrees the blade foot is vertically disposed in the ground as it travels from position 2 to position 3. Then, the bladed foot is raised from the ground as it travels through the next 72 degrees of rotation between positions 3 and 4, the latter being at 216° of rotation. During the next 144 degrees of rotation of the blade foot, it will move through its highest position 5 and then return to position 1. Thus, the blade foot pushes against the ground to provide traction without being at an angle that tends to scoop up the ground and deposit it in the water causing increased turbidity.

Each blade foot 106 is quite wide, as best seen in FIG. 11 and it extends between a pair of supporting, vertically extending main drive hubs 120. There are five arms 120a on each of these respective hubs projecting outwardly from a central hub portion 120b (FIG. 11a) at which the main drive hubs have a central bore 120c in which is disposed a main drive shaft 124 which extends horizontally through each blade foot assembly as best seen in FIG. 11. The main drive hubs are fixed to the main drive shaft and are rotated by the main drive shaft. The left end of the main drive shaft 124 is mounted for rotation in a frame 118 and is driven by a horizontal output shaft of a vertically extending transmission gear box 126 which is driven by an output shaft 127 of an overhead motor 102a, which is preferably a high torque, submersible gear motor. Manifestly, other motors may be used other then this gear motor. The drive motor 102 and transmission are carried in the frame which also comprises a large horizontally extending frame portion 118a which extends horizontally from the motor drive frame 118 to the right as seen in FIG. 11 to a depending, stationary, vertical frame plate 118b. The lower end of the frame plate 118b carries a bearing mount 130 for the right hand of the main drive shaft 124 when viewing the main shaft in FIG. 11. The left end of the main drive shaft is supported in a bearing mount 130a adjacent the output drive of the transmission gear box 126.

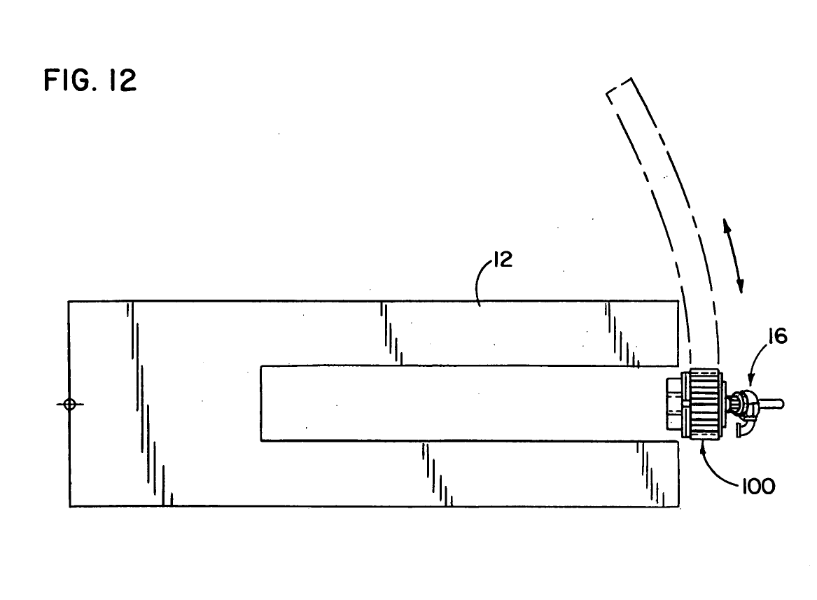

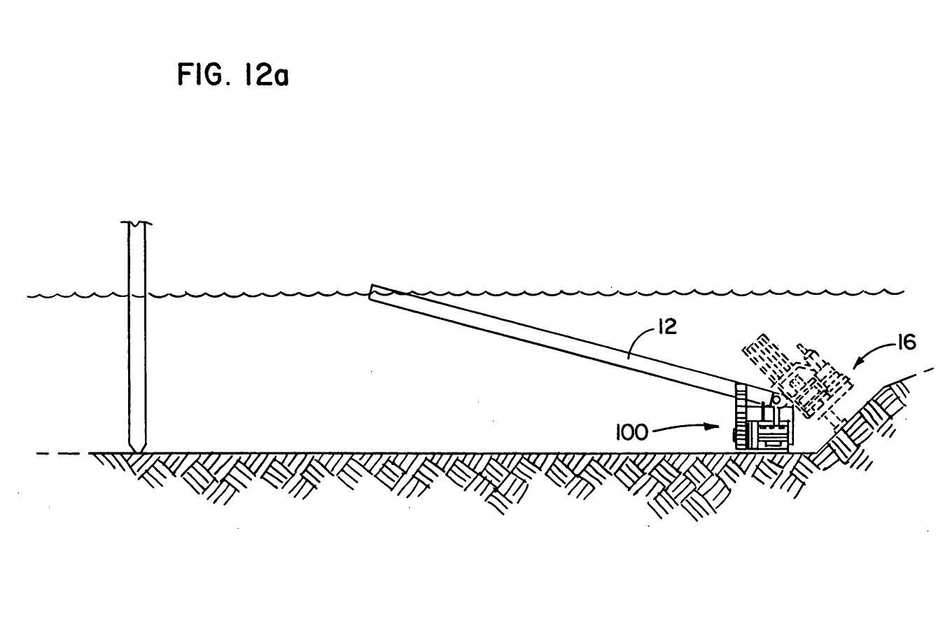

The main drive shaft 124 is used to drive the blade feet 106 into the ground and to propel the boom 12 and suction head 16 forwardly in the swing direction as illustrated in FIG. 12 and FIG. 12a. As shown in FIG. 12a, the motor drive 102 is located closest to the dredge and is supported on the outer end of the boom adjacent the pump head unit. The outer, vertical frame place 118b is disposed close to the pump unit.

The blade feet 106 are raised and lowered and swung through 360 degrees travel path by an eccentric drive 140 that preferably, comprises a rotating eccentric hub 142 and a connector link 144 (FIG. 11b). The illustrated eccentric hub 142 is a pentagon shaped plate having a central bore 145 in which is received a circular eccentric cam 148 which is fixed to the main drive shaft 124 at an off-center eccentric throw distance. That is, the center of the disk shaped, eccentric cam is displaced by a predetermined distance from the rotational axis of the main drive shaft 124. The rotating eccentric hub 142 carries five cam follower rollers 150 equally spaced about the eccentric hub. Each cam follower comprises a roller 150a being mounted on a horizontal shaft 150b with each roller having rolling engagement of the periphery of the eccentric cam 148.

Extending between the rotating eccentric hub 142 and the inner one of the main drive hubs 120 are the fine connector links 130 (FIG. 11b).

The upper end of each connector link 130 has a circular aperture 144a which is sized to mount on a horizontal shaft and bearing mount 142a. A lower, square aperture 144b is formed in each of the five connector links 144 to prevent the walking feet from rotating relative to the links. This connector link assembly maintains the respective blade feet oriented in the vertical direction as the main drive hubs 120 rotate and the respective blade feet make the revolution illustrated in FIG. 13.

From the foregoing, it will be seen that the motor drive 102 drives the transmission gear box 126 to turn the main drive shaft 124 to rotate the eccentric cam 148 and to rotate main drive hubs 120 fixed to the main drive shaft. The eccentric cam is followed by the cam follower rollers 150 which move each of the respective blade feet 106 down into the ground between positions 1 and 2, as seen in FIG. 13 and then through 72 degrees of traction before leaving between positions 3 and 4 while the next following traction foot 106 is moving into the ground at position 2 to continue the traction. Thus, the motor drive 102 drives each of the bladed feet 106 into the ground and to provide an endless path drive or bladed feet to keep swinging the boom 12 first in one direction and then in the opposite direction to make the cut in a continuous manner without having to have a swing system that includes the anchor points and the swing cables as well as a crew to reposition anchor points. It will be seen that the system provides a good traction with a minimum of turbidity and eliminates the need for maintaining expensive anchor barge and crew to move the heavy anchors and the resulting loss of production time while the dredge anchors are being repositioned. Also, it will be seen from the foregoing that the embodiment illustrated in the FIGS. 6, 7 and 11-13 provides a unique traction system for engaging the bottom and moving the suction inlet to the left and the right by a submerged drive system that does not require any barge or overhead system to aid in the shifting of the boom to swing through the cuts.

Further, it will be seen from the foregoing that the system provides a submersible drive combination that includes a submersible drive for the suction pump as well as a submersible drive for the low turbidity around the suction inlet which prevents large debris and sticky material from clogging the pump inlet and a submersible drive for the traction or walking system for engaging and moving the intake head along the ground in the sweep of a cut while dredging. Use of the submersible pump rotating head and rotating walking system provides unique advantages particularly for remediation dredging.

While the illustrated embodiment is disclosed and directed to use with a typical installation of an outdoor reclamation of contaminated material from a harbor bottom located underneath a large body of water, it is understood that contaminated material or the material being dredged could be located in a large tank having a liquid other than water and having the suspended material at the bottom of the tank which is desired to be removed while in the highly concentrated form. That is the present invention is not limited to a particular use of a conventional dredge but can be also used to remove material from tanks or the like or in other environments where the liquid is not water but is some other chemical liquid.

1. An environmental dredging method having a suction head for removing a contaminated layer from a bottom of a body of water comprising:
measuring the depth of the contaminated material layer;
adjusting the force at which the suction head engages the bottom to remove the measured contaminated layer without removing a thicker layer of uncontaminated ground underneath the measured contaminated layer;
using a suction head connected to a pump to intake the contaminated layer from the bottom; and
guiding the suction head to travel along a path of movement that removes a substantially uniform layer of contaminated material from the bottom.

2. A method in accordance with claim 1 comprising:
shifting the pump suction head by a walking traction system to make an arcuate cut of the bottom.

3. A method in accordance with claim 1 comprising:
covering the suction head with a shroud to reduce turbidity associated with removal of the contaminated layer.

4. A method in accordance with claim 1 wherein the guiding of the suction comprises:
positioning the suction head to stay level with the bottom of the cut when the suction head is taking a shallow or deeper water cut.

5. A method in accordance with claim 1 wherein the guiding of the suction head comprises:
providing a swingable boom having the suction head pivotally mounted on an outer end of the boom; and
providing a system to position the suction head to point straight ahead in the direction of dredge advancement as the boom swings during the making of a cut.

6. In a dredge system for dredging target material, the combination comprising:
a dredge;
a pump on the dredge;
a suction line connected to the pump for conveying the flow of slurry and having an inlet for the suction line;
an articulated head having a suction line inlet thereon and swingable from side-to-side to make a cut;
a load sensor for sensing the load on the articulated head in order to maintain the articulated head in close proximity to the target material; and
a load system connected to the articulated head to control the load that the articulated head applies to the target material as the articulated head is swung from side-to-side.

7. A dredge system in accordance with claim 6 wherein the dredge comprises:
a floating dredge body; and
a boom attached to the dredge at one end and connected to the articulated head at its other end.

8. A dredge system in accordance with claim 7 wherein the load system comprises:
a controller connected to the load sensor; and
a winch operable to control the load which the articulated head applies to the target material, the controller adjusting the winch to maintain the proper load of the articulated head to the target material to remove softer target material and to ride on the top of an underlying harder substrate.

9. In a dredge:
a pump on the dredge;
an intake line connected to the pump and having an intake for removing target material which is under water;
a rotary head mounted on the dredge for rotation about the intake for the main suction line and having larger and smaller ends thereon; and
a head cleaner for cleaning the rotary head.

10. A dredge in accordance with claim 9 wherein the rotary head is substantially shaped as a cone.

11. A dredge in accordance with claim 10 wherein the head comprises:
spaced rings of decreasing diameter towards the distal end of the rotary head; and
spaced bars extending longitudinally between the rings and disposed internally within the rings and joined thereto.

12. A dredge in accordance with claim 9 wherein the head cleaner comprises:
a fixed comb mounted exteriorly of the rotary head for cleaning the rotary head.

13. A dredge in accordance with claim 12 wherein the fixed comb comprises:
fingers that protrude between the rings to remove debris stuck between the rings.

14. A dredge in accordance with claim 9 comprising:
a flexible shroud associated with the suction head to prohibit contaminated material from an unwanted leaving of a suction area at the suction head.

15. A dredge system comprising:
an intake pump for creating suction;
a hollow suction line connected to the pump and having an intake through which liquid flows;
a movable head connected to the suction line and associated suction line to apply suction to remove material from the bottom, the head being movable left and right to take successive cuts from the bottom; and
a traction system for engaging the bottom and moving the suction line intake to the left and to the right when making the cuts to the bottom.

16. A dredge system in accordance with claim 15 wherein the traction system for engaging the bottom comprises:
a walking system having members that travel along an endless path for engagement with the bottom.

17. A dredge system in accordance with claim 16 comprising:
a motor drive for rotating the rotating members into engagement with the ground.

18. A dredge system in accordance with claim 16 wherein the members comprise bladed feet that are substantially vertically disposed in the ground.

19. A dredge in accordance with claim 18 wherein the bladed feet enter and leave the ground while in a substantially vertical position.

20. A dredge in accordance with claim 19 wherein the bladed feet have a face that pushes directly against the shear strength of the bottom material without tearing the bottom material up and out to provide traction without a large amount of turbidity.

21. A dredge in accordance with claim 18 wherein a bladed foot is being removed from the ground while another bladed foot is entering the ground.

22. A dredge in accordance with claim 15 comprising:
the pump being mounted on the articulated head; and
the traction system being mounted adjacent the pump.

23. A dredge in accordance with claim 15 wherein the traction system is mounted on the swinging boom behind the pump.

24. A dredge in accordance with claim 23 wherein a rotating cone head is mounted on the articulated head adjacent the suction inlet; and
a shroud is mounted at sides of the cone head and limits material being dug by the cone from escaping the cone thereby reducing the turbidity caused by the cone.

25. A dredging system for dredging material submerged from a bottom located under a liquid body comprising:
a dredge for floating on a liquid body;
a boom mounted on the dredge and moveable to make successive cuts of the submerged material;
an intake pipe carried by the boom and having an inlet;
a submersible pump connected to the intake pipe and submerged in the liquid to provide suction to pull the material on the bottom into the intake pipe inlet;
a rotating head located at the pipe inlet to move along the bottom and to having openings sized to prevent clogging of the pump inlet by debris;
a submersible drive motor mounted on the boom for the rotating head submerged in the liquid and rotating the head;
a submersible traction drive mounted on the boom for moving the boom and pipe inlet long a dredging cut; and
a submersible drive motor for driving the traction drive to move the boom along the cut.

26. A dredging system in accordance with claim 25 comprising:
a submersible positioning system for positioning the suction head in the direction of dredge advancement as the boom swings to be at an angle to the dredge.

27. A dredging system in accordance with claim 25 comprising:
a submersible drive for positioning the suction head to point substantially in the direction of dredge advancement while the boom is at various angles to the dredge as it travels through a cut.

28. In a dredging system for dredging material under a body of liquid comprising:
a dredge for floating on the liquid and for advancing in a predetermined direction;
a boom pivotally mounted on the dredge for pivoting about a connection to the dredge to swing to the left and to the right about the connection to the dredge to make cuts in the material being dredged;
a suction head mounted on a submerged end of the boom for swinging motion relative to the submerged end of the boom; and
a drive for positioning the suction head to point substantially in the direction of dredge advancement while the boom is at various angles to the dredge.

29. A dredging system in accordance with claim 28 wherein the drive comprises:
parallelogram linkages and fluid transfer systems.

30. A dredging system in accordance with claim 28 wherein the drive comprises:
means for sensing the change in swing angle of the boom relative to the dredge in direction of the swinging of the boom; and
a force applying means to cause the suction head to swing relative to the boom to counteract the swinging of the boom to keep the suction head pointing in the direction of the dredge advancement.

31. A dredging system in accordance with claim 30 wherein the means for sensing the change in swing angle of the boom comprises:
a fluid cylinder connected between the dredge and the boom.

32. A dredging system in accordance with claim 30 wherein the force applying means comprises:
a fluid cylinder connected between the boom and the suction head.

33. A dredging system in accordance with claim 28 wherein the drive comprises:
a first hydraulic cylinder connected between the dredge and the boom for compressing and expelling hydraulic fluid when the boom swings in a first direction and to take in hydraulic fluid when the boom swings in the opposite direction;
a second hydraulic cylinder connected between the boom and the suction head to intake hydraulic fluid when the boom swings in the first direction and to compress and expel hydraulic fluid when the boom swings in the opposite direction; and
a hydraulic circuit providing fluid flow between the respective first and second hydraulic cylinders.

34. In a dredging system for dredging material under a body of liquid comprising:
a dredge for floating on the liquid and for advancing in a predetermined direction;
a boom pivotally mounted on the dredge for pivoting about a connection to the dredge to swing to the left and to the right about the connection to the dredge to make cuts in the material being dredged;
a suction head mounted on a submerged end of the boom for swinging motion relative to the submerged end of the boom; and
a positioning device to position the suction head to stay level with the bottom of the cut when suction head is making an upper shallow water dredging cut and making a deeper water dredging cut.

35. A dredging system in accordance with claim 34 wherein the positioning device comprises:
a parallelogram linkage on the boom having the suction head mounted on a vertical, outer portion of the parallelogram linkage.

36. A dredging system in accordance with claim 35 wherein the parallelogram linkage comprises:
upper and lower links extending lengthwise relative to the boom and swingable to be positioned closer together as the boom swings downwardly.

37. In a dredge for dredging slurry, the combination comprising:
an intake pump for creating suction;
a hollow suction line connected to the pump and having an intake through which the slurry passes;
a sensor for sensing a characteristic of the slurry traveling through the suction line;
a bypass intake connected to the main suction line to admit liquid into the suction line to dilute the slurry in the intake line to increase the velocity flow;
a valve system for allowing slurry flow through the main suction line and bypass lines and for selectively restricting flow through the main suction line and for allowing liquid flow through the bypass line into the main suction line to dilute the slurry and increase the velocity of flow in the main suction line; and
a controller connected to the sensor and connected to the valve system for operating the valve system to switch between a dilution mode and a main suction mode.

38. A dredge in accordance with claim 37 wherein the valve system comprises:
a bypass valve in the bypass line operable between open and closed positions by the controller; and
a main suction line valve in the main suction line operable between open and closed positions by the controller.

39. A dredge in accordance with claim 38 herein the bypass and suction line valves are each knifegate valves.

40. A dredge in accordance with claim 37 wherein the bypass line and the main suction line are joined at a Tee.

41. A dredge in accordance with claim 37 wherein the sensor is a flow velocity sensor for sensing the velocity of liquid flow.

42. An environmental dredging method having a suction head to remove a predetermined layer of material from a bottom below a body of water, the method comprising:
adjusting the force with which the suction head engages the bottom to remove the layer of material;
shifting the suction head from side-to-side to make a cut;
pointing the suction head straight ahead in the direction of travel along the bottom when making a side-to-side cut; and
maintaining the suction head to stay substantially level with the bottom when the suction head is making a cut in both shallow and deeper water.

43. A method in accordance with claim 42 wherein the maintaining of the suction head to stay substantially level with the bottom comprises:
mounting the suction head on a dredge boom with a parallelogram linkage that keeps the suction head at a predetermined angle to the bottom as the angle of the boom between the surface of the body of water and a lower end of the boom increases when making a cut in deeper water.

44. A method in accordance with claim 42 comprising:
pivotally mounting the suction head on the outer end of the boom which swings from side-to-side when making a cut; and
swinging the boom to the left and shifting the suction head in the opposite direction to keep the suction head pointed straight ahead in a direction of travel and swinging the boom to the right and shifting the suction head in the opposite direction to keep the suction head pointed straight ahead in the direction of travel.

45. A method in accordance with claim 42 wherein the adjusting of the force comprises:
providing a load controlling system for sensing the load being applied by the suction head to the layer of material and for adjusting the load to a value to remove the layer of material with a reduced amount of overdredged material.

46. In a dredging system for dredging material from the bottom of bodies of water of varying depth;
a dredge;
an articulated boom mounted on the dredge having an outer, lower end for positioning below the surface of the body of water and swingable through an increasing angle with the surface of the body of water as the outer end of the boom is lowered between shallower and deeper water to reach the bottom;
a suction head adjustably mounted on the lower end of the boom for removing a layer of material from the bottom; and
a leveling device for adjusting the suction head to maintain the suction head to stay in a substantially level position with respect to the bottom as the lower end of the boom dredges material in deeper water.

47. A dredging system in accordance with claim 46 wherein the leveling device comprises:
a parallelogram linkage mounted on the boom and connected to the suction head.

48. A dredging system in accordance with claim 47 wherein the parallelogram linkage comprises:
a pair of long link members extending along the length of the boom;
a rear link member connected to rear ends of the long link members; and
a forward link member connected to the forward ends of the long link members.

49. A dredging system in accordance with claim 46 comprising:
a cone-shaped guard about the suction head; and
the leveling device positioning the cone at a angle such that a side of the cone adjacent the bottom is maintained substantially parallel to the bottom in shallow and deeper bodies of water.
